(19) United States
(12) Patent Application Publication
(10) Pub. No.: US 2008/0173335 A1
(43) Pub. Date: Jul. 24, 2008

(54) Semiconductor Wafer Cleaning System

(75) Inventors: Jin No Yoon, Gyeonggi-do (KR); Jin Tae Kim, Gyeonggi-do (KR)

Correspondence Address: INTELLECTUAL PROPERTY / TECHNOLOGY LAW, PO BOX 14329, RESEARCH TRIANGLE PARK, NC, 27709, US

(73) Assignee: DOOSAN MECATEC CO., LTD, Gyeongsangnam-do (KR)

(21) Appl. No.: 11/910,977

(22) PCT Filed: Apr. 4, 2005
(86) PCT No.: PCT/KR05/01036

§ 371 Date: Oct. 8, 2007

(51) Int. Cl. B08B 13/00

(52) U.S. Cl. 134/62; 134/198; 134/63

(57) ABSTRACT

The present invention related to a semiconductor wafer cleaning system comprising a preliminary cleaning station for removing particles on a wafer in advance by spraying deionized water thereon; a first cleaning station for cleaning remaining particles firstly by rotating frictionally a pair of brushes disposed to be contacted with a front surface and a back surface of the wafer and by spraying chemicals thereon through a chemical sprayer being provided independently; a first rinsing station for rinsing by spraying a cleaning liquid onto the firstly cleaned wafer at the first cleaning station; a second cleaning station for cleaning particles secondly remained on the front surface and the back surface of the wafer by spraying the chemicals onto the firstly rinsed cleaned wafer at the first rinsing station through a chemical sprayer being provided independently using the same structure and manner as those of the first cleaning station; a second rinsing station for rinsing by spraying the cleaning liquid onto the secondly cleaned wafer at the second cleaning station; and a dry station for drying the remained cleaning liquid using centrifugal force generated by rotating the rinsed wafer at the second rinsing station at a high speed. According to the present invention, a waiting time of entry into each cleaning station is minimized by processing a cleaning operation and a rinsing operation of a surface-polished wafer in a cleaning station and a rinsing station which are provided separately and independently thereby improves wafer productivity significantly by solving a delayed phenomenon in a whole process of wafer manufacturing.

### TECHNICAL FIELD

The present invention relates to a semiconductor wafer cleaning system. More specifically, the present invention relates to a semiconductor wafer cleaning system which minimizing a waiting time of entry of wafers into each cleaning station provided separately by independently processing cleaning and rinsing operations of a wafer having a polished surface in each cleaning station, and thus improves wafer productivity by solving a delayed phenomenon in a whole process of wafer manufacturing.

### BACKGROUND ART

Generally, a manufacturing process of a semiconductor wafer comprises a step of polishing a surface of a wafer by using a chemical mechanical polisher (a CMP tool), etc. and a step of cleaning a wafer for removing particles produced in the step of polishing a surface of a wafer, etc.

The step of cleaning a wafer is performed in various methods by applying various types of cleaning systems of a semiconductor which are known presently in the art. Typically, the step of cleaning a wafer comprises spraying and cleaning certain chemicals onto a wafer surface in one cleaning station and rinsing the wafer surface by using pure water, i.e., deionized water (DIW); repeating the spraying and cleaning, and rinsing processes several times after moving the wafer into subsequent cleaning stations; and drying the wafer finally after inserting it into a dry station. This is, a cleaning process by chemicals and a rinsing process by deionized water are performed separately in one station.

Accordingly, because both cleaning and rinsing processes are performed in one cleaning system in a prior art semiconductor wafer cleaning system, it is time consuming in performing such processes in a single station. In addition, such cleaning and rinsing processes must be repeated several times in subsequent stations which accelerates the time consumption greatly and leads to a delay in time so that a wafer polished on a platen of a polishing module needs to wait for entering into the cleaning system and thus causes a lag in view of a whole process and thus lowers wafer productivity due to an impossibility of maintaining the flow of the whole process smoothly.

That is, when performing a cleaning process using two or more chemicals in one cleaning station, a rinsing process for neutralization is necessarily required to avoid a pH shock due to a difference in chemical components between the respective cleaning processes according to the chemicals being used. For this purpose, a pair of cleaning brushes made of wetting sponge is used, where each of the brushes is arranged near both sides of the wafer, respectively, and rotatingly brushes up the wafer, is used. Because a chemical for cleaning and deionized water for rinsing are alternatively and repeatedly provided through each brush axle, an initial stage for a cleaning change where different chemical is provided can not maintain concentration of the different chemical exactly for a certain period of time by deionized water already included in one of the brushes so that the cleaning effect is lowered. Therefore, a longer cleaning time is required in order to perform a normal cleaning process which causes productivity to be lowered.

Further, a highly contaminated wafer due to polishing process is inserted directly into a cleaning station through the brushes described above and cleaned immediately, without performing a certain preliminary cleaning process in the prior art cleaning system, so that the contamination of the brushes becomes worse and cleaning power is lowered. In addition to that, the brushes are shortened in their duration and thus are required to be replaced frequently which leads to inconvenience of maintenance of a CMP tool and an increase of the process costs as well.

Moreover, in a dry station for drying the wafer by rotating at a high speed after completing the cleaning and rinsing processes several times through respective cleaning stations, a grip structure for gripping and rotating the wafer is comprised of four grip fingers which are simultaneously operated in a radial direction. When a flat zone type wafer is inserted into a cleaning station in a condition that the flat zone position of the wafer is not aligned exactly, the grip conditions of the respective grip fingers are not uniform and thus the wafer being rotated at a high speed is highly vulnerable to breakdown. Thus, an alignment of wafer is necessarily required, which lags a whole process due to a time delay by the time to be needed for the alignment and in turn lowers wafer productivity additionally.

Yet, a prior art semiconductor wafer cleaning system has a large structure where respective cleaning, rinsing and drying stations are arranged in a row so that a wide and large space is required to install and apply the prior art cleaning system.

### DISCLOSURE OF INVENTION

### Technical Problem

The object of the present invention is to solve the prior art problems and provide a semiconductor wafer cleaning system without a delayed phenomenon in a whole process of manufacturing wafers and with improved wafer productivity by minimizing a waiting time of entry of wafers into each cleaning station after processing respective cleaning and rinsing operations of wafers independently.

Yet another object of the present invention is to provide a semiconductor wafer cleaning system with improved wafer productivity by improving a cleaning effect through separation of a supplying structure of chemicals from that of deionized water and shortening the time required for cleaning as well.

Yet another object of the present invention is to provide a semiconductor wafer cleaning system with a maximized cleaning capability and a minimized contaminated brushes by performing a main cleaning process with the brushes in a condition that a heavily contaminated wafer through a polishing process is purged to a certain level, and with cost-effectiveness required to perform the whole processes due to the extended lifetime of the brushes as well.

Yet another object of the present invention is to provide a semiconductor wafer cleaning system with improved wafer productivity which not only embodies a stable structure without a damage concern of wafers when rotating the wafers even at a high speed by maintaining a grip condition constantly regardless of the direction of a wafer entry to be inputted by improving a grip structure of wafers in a dry station for rotating and drying the wafers, but also is able to generalize such a stable structure regardless of wafer types thereby needs not perform a separate alignment of wafer and shortening the time required for the whole processes.

Yet another object of the present invention is to provide a semiconductor wafer cleaning system with a maximized space-effectiveness due to a minimized space for the tools to be installed by improving and compacting structural arrangement of each station for cleaning, rinsing, and drying.

### Technical Solution

To achieve the above object, a semiconductor wafer cleaning system according to one aspect of the present invention comprises a preliminary cleaning station for removing particles on a wafer 1 in advance by spraying deionized water thereon; a first cleaning station for cleaning remaining particles firstly by rotating frictionally a pair of brushes disposed to be contacted with a front surface and a back surface of the wafer and by spraying chemicals thereon through a chemical sprayer being provided independently; a first rinsing station for rinsing by spraying a cleaning liquid onto the firstly cleaned wafer at the first cleaning station; a second cleaning station for cleaning particles secondly remained on the front surface and the back surface of the wafer by spraying the chemicals onto the firstly rinsed cleaned wafer at the first rinsing station through a chemical sprayer being provided independently using the same structure and manner as those of the first cleaning station; a second rinsing station for rinsing by spraying the cleaning liquid onto the secondly cleaned wafer at the second cleaning station; and a dry station for drying the remained cleaning liquid using centrifugal force generated by rotating the rinsed wafer at the second rinsing station at a high speed.

Herein, it is preferable that the first rinsing station further comprises a direction change and transfer device for changing the moving direction of the firstly cleaned wafer into a subsequent process by 90 degrees against the entry direction of the firstly cleaned wafer into the first rinsing station and transferring the firstly cleaned wafer thereinto.

Further, it is preferable that the direction change and transfer device comprises a ascending and descending plate being disposed vertically and ascended and descended by a certain linear motion device; a plurality of roller brackets being fixed to one side wall of the ascending and descending plate vertically in parallel with a constant gap therealong and being arranged between transfer conveyers for transferring the wafer from a previous process without interference between the roller brackets and the transfer conveyers; and a plurality of direction change and transfer rollers being supported in a manner that the direction change and transfer rollers are arranged inside the roller brackets, respectively so that both ends of the direction change and transfer rollers are rotatable between one side wall of the ascending and descending plate and an end of the roller brackets.

In addition, it is preferable that the preliminary cleaning station comprises a wafer grip and rotation device; and a deionized water sprayer being installed on top of the wafer for mainly removing heavy particles by spraying deionized water in a water screen shape when feeding highly pressured deionized water; wherein the wafer grip and rotation device comprises a supporting plate in which an ascending and descending guide rail is formed along a vertical direction; an ascending and descending plate being combined with the ascending and descending guide rail in order to be guided by the ascending and descending guide rail; a cylinder being extended and contracted vertically to ascend and descend the ascending and descending plate; and a plurality of guide rollers being to be rotated simultaneously by one or more driving sources to rotate the wafer after gripping it and being ascended and descended together with the ascending and descending plate in order not to interfere with the wafer when loading and unloading the wafer.

In addition, it is preferable that the first cleaning station and the second cleaning station respectively comprise a pair of brushes for cleaning the wafer by contacting with both surfaces thereof and being made of a wetting sponge capable of wetting treatment upon being supplied deionized water only through a flow path for supplying deionized water when the brushes idle; and a chemical sprayer being disposed symmetrically toward both side surfaces of the wafer and being capable of passing chemicals only and spraying them.

In addition, it is preferable that the dry station comprises a central rotation axle being extended upward which is rotated by a power transferred from a driving device provided at a bottom thereof; five cut-outs being formed at the top of the central rotation axle along an outer circumference thereof with equidistance in a longitudinal direction thereof; operational levers being protruded through the five cut-outs, respectively, in a radial direction, and having a same distance and being capable of moving upward and downward therealong, respectively; finger arms being provided vertically in a manner that each finger arm is combined with one end of each operational lever in a rotatable condition by way of a hinge pin so that each finger arm is engaged with each operational lever as each operational lever moves; grip fingers being formed integrally with the finger arms, respectively, on top of the finger arms, each grip finger having a groove capable of receiving an edge of the wafer; a connection member being provided between a top portion of the hinge pin of the finger arm and the grip finger; and, in the connection member, a central axis pin being connected to a sitting plate for supporting the wafer when being loaded and functions a pivot axis to perform a relative swing motion between the finger arms and the grip fingers.

### Advantageous Effect

According to the semiconductor wafer cleaning system, it is accomplished that a waiting time of entry into each cleaning station is minimized by processing a cleaning operation and a rinsing operation of a surface-polished wafer in a cleaning station and a rinsing station which are provided separately and independently thereby improves wafer productivity significantly by solving a delayed phenomenon in a whole process of wafer manufacturing.

In addition, it is accomplished that a cleaning effect is improved by separating a structure of supplying chemicals and deionized water and is wafer productivity is also improved by shortening the cleaning time at each station. That is, by separating the structure of supplying chemicals and deionized water into supplying chemicals by a separately provided chemical sprayer and supplying deionized water by brushes, there is no concern of a chemical shock due to a difference in components between different chemicals when performing a cleaning process using two or more chemicals in one cleaning station and it is possible to maximize the cleaning effect by maintaining the exact concentration of the chemicals, and therefore wafer productivity is improved by shortening the cleaning time.

Further, according to the present invention, it is accomplished that a cleaning operation is performed by brushes in a condition that a highly contaminated wafer after completing a polishing process is purged in some extent due to providing a preliminary cleaning station capable of performing a preliminary cleaning process separately before performing a main cleaning process by the brushes thereby maximizes the cleaning performance by minimizing the contamination of the brushes, saves process costs due to an extension of duration of the semiconductor wafer cleaning system, and accomplishes advantage in terms of maintenance of the system.

In addition, according to the present invention, it is accomplished that a stable structure is embodied for maintaining a constant grip condition regardless of an input direction of a wafer and without any breakage of the wafer when rotating it at a high speed by improving a wafer grip structure into a five grip finger type, and it is possible to generalize the stable structure regardless of wafer types such as a flat zone type or a notch type thereby there is no need to perform a separate alignment of wafer so that improves wafer productivity by shortening the time required for the whole processes.

Further, according to the present invention, it is accomplished that the effectiveness of an occupied space of the whole unit is maximized due to a minimized provision space by providing one of cleaning, rinsing and drying stations with a direction change and transfer device thereby improving one of cleaning, rinsing and drying stations into an L-type arrangement.

### BRIEF DESCRIPTION OF THE DRAWINGS

FIG. 1 is a schematic view of a disposition structure regarding respective sections of a semiconductor wafer cleaning system and a connectivity thereof with peripheral devices such as a polishing module and a wafer receiving module in a plane in accordance with the present invention.

FIG. 2 is a perspective view of a main structure of a preliminary cleaning station for removing large particles by a water screen type sprayer of deionized water which is applied to a cleaning system of the present invention.

FIG. 3 is a cross-sectional view along the III-III line illustrated in FIG. 2.

FIG. 4 is a perspective view of a main structure of a first cleaning station and a second cleaning station by wetting brushes which is applied to a cleaning system of the present invention.

FIG. 5 is a vertical cross-sectional view illustrating a flow structure of deionized water in a brush which is applied to a first cleaning station and a second cleaning station.

FIG. 6 is a perspective view of a main structure of a first rinsing station arranged between a first cleaning station and a second cleaning station for performing a rinsing process after a cleaning process by a first cleaning station and for changing a transfer direction of a wafer.

FIG. 7 is a schematic top view illustrating a condition where a wafer cleaned by a first cleaning station is entered into an inside of a first rinsing station by a transfer conveyer.

FIG. 8 is a schematic side view illustrating a condition where a wafer is raised upward from a transfer conveyer by ascending a direction change and transfer roller between transfer conveyers.

FIG. 9 is a schematic top view illustrating a condition where a wafer sitting on direction change and transfer rollers is transferred into a second cleaning station with the wafer being in a changed direction, as the direction change and transfer rollers rotate.

FIG. 10 is a perspective view of a main structure of a second rinsing station which performs a rinsing process after cleaning process by the second cleaning station.

FIG. 11 is a perspective view of a main structure of a dry station utilizing centrifugal force applied to the present invention.

### BEST MODE FOR CARRYING OUT THE INVENTION

Hereinafter, a semiconductor wafer cleaning system according to preferred embodiments of the present invention is described in more detail by reference to the accompanying drawings.

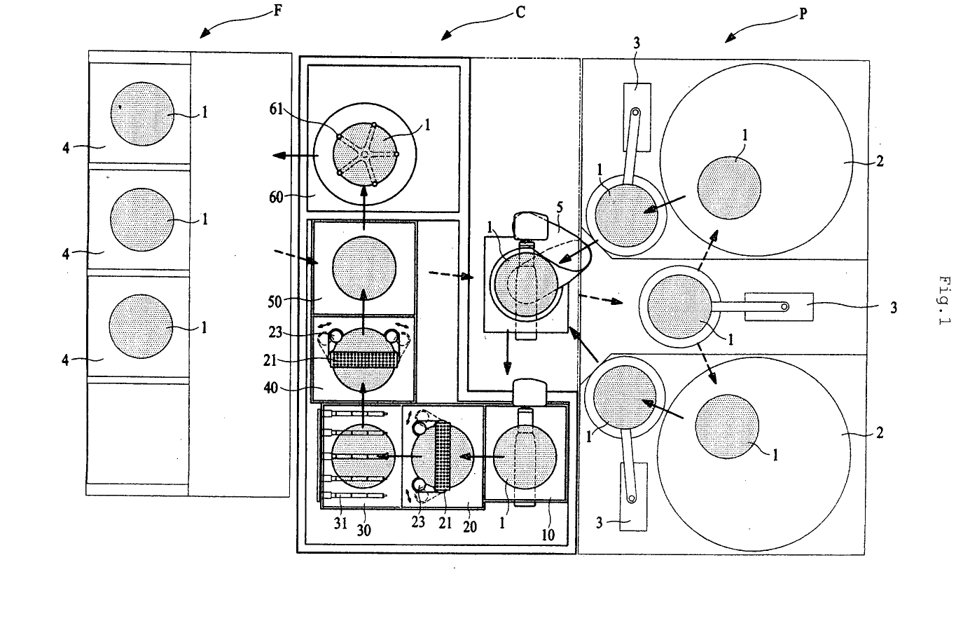

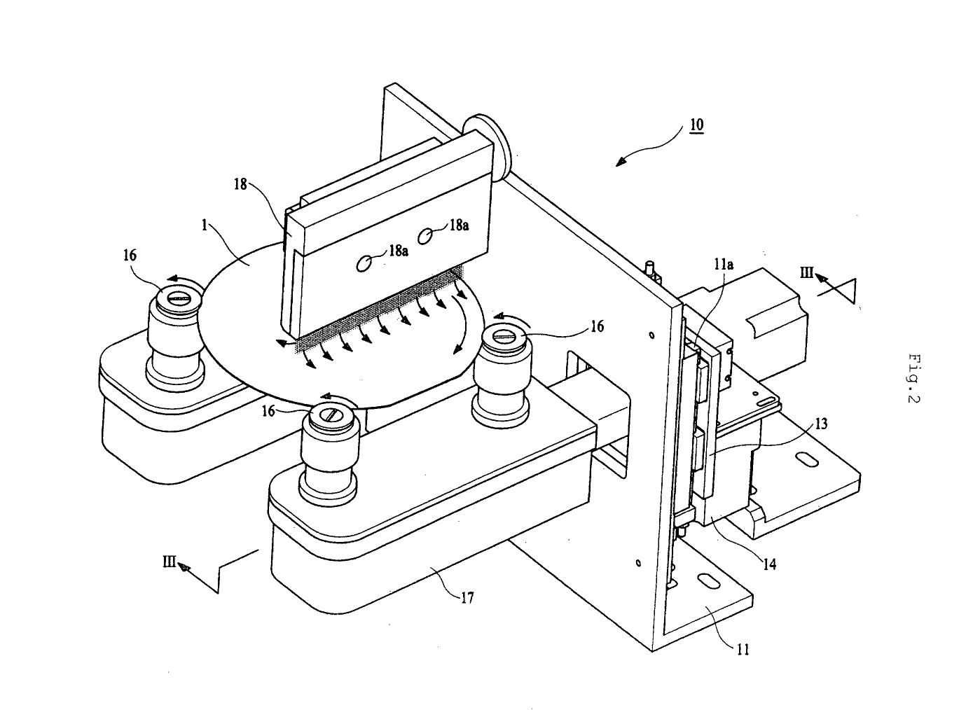

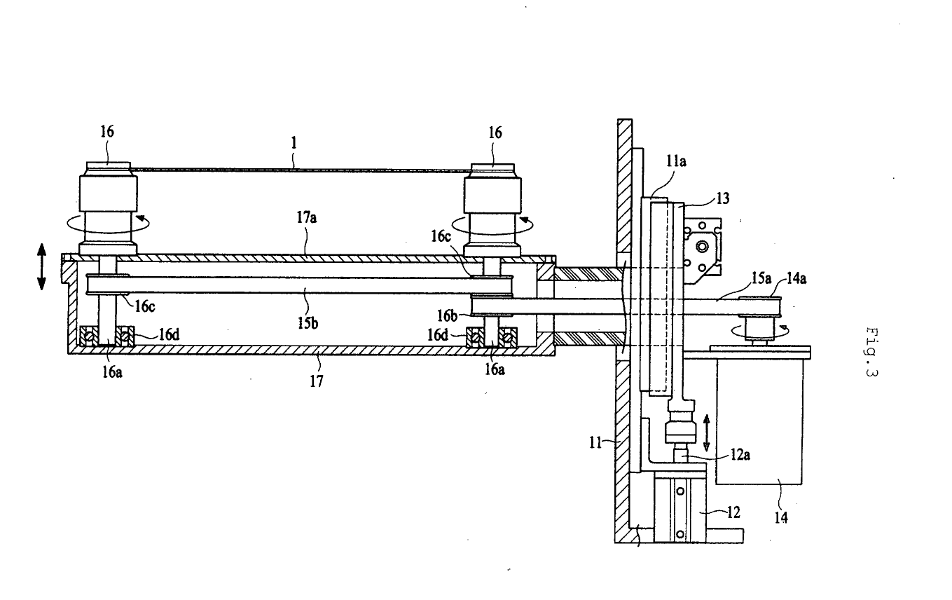

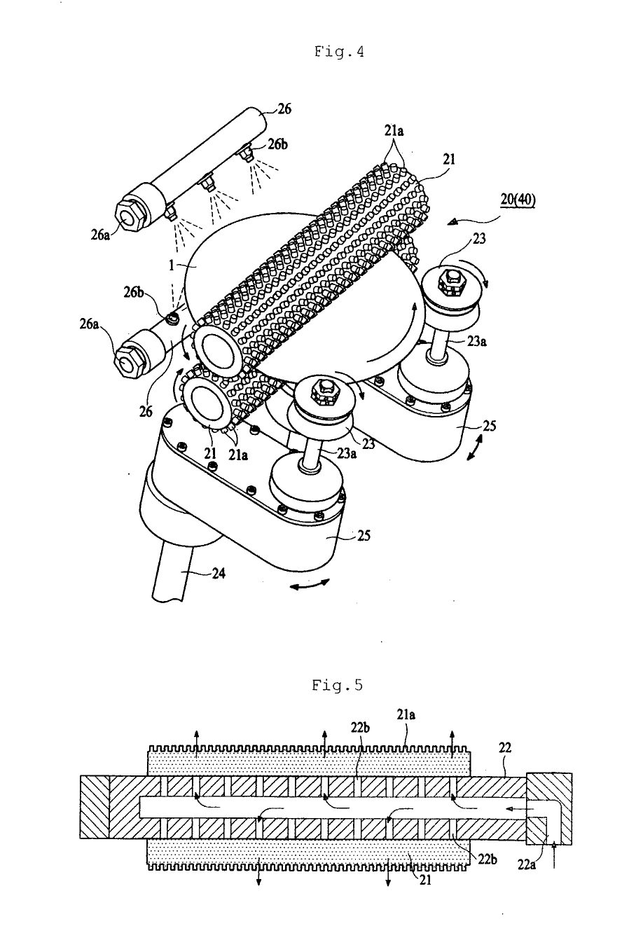

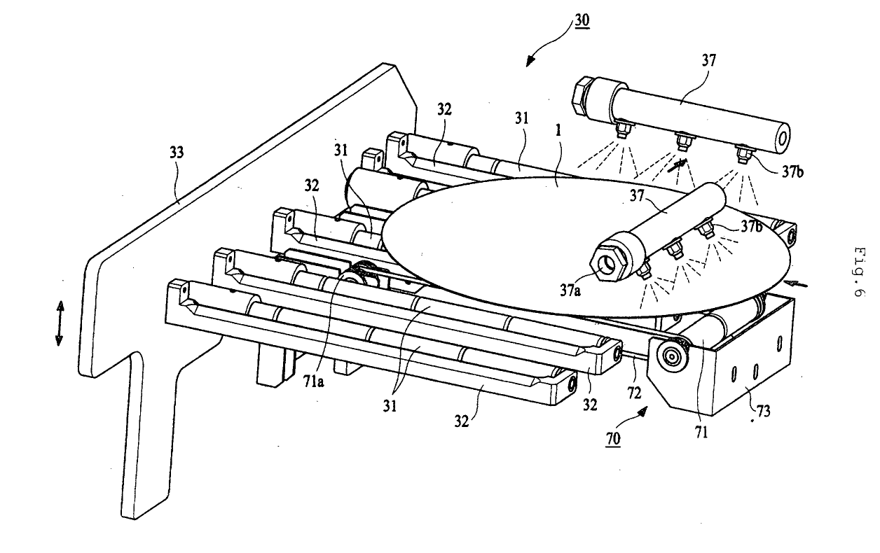

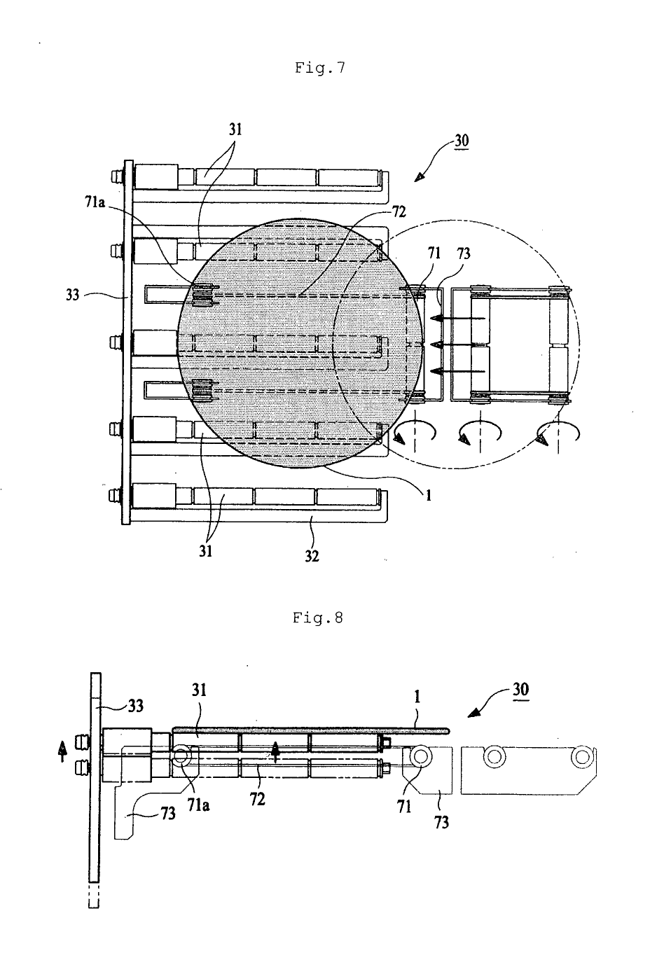

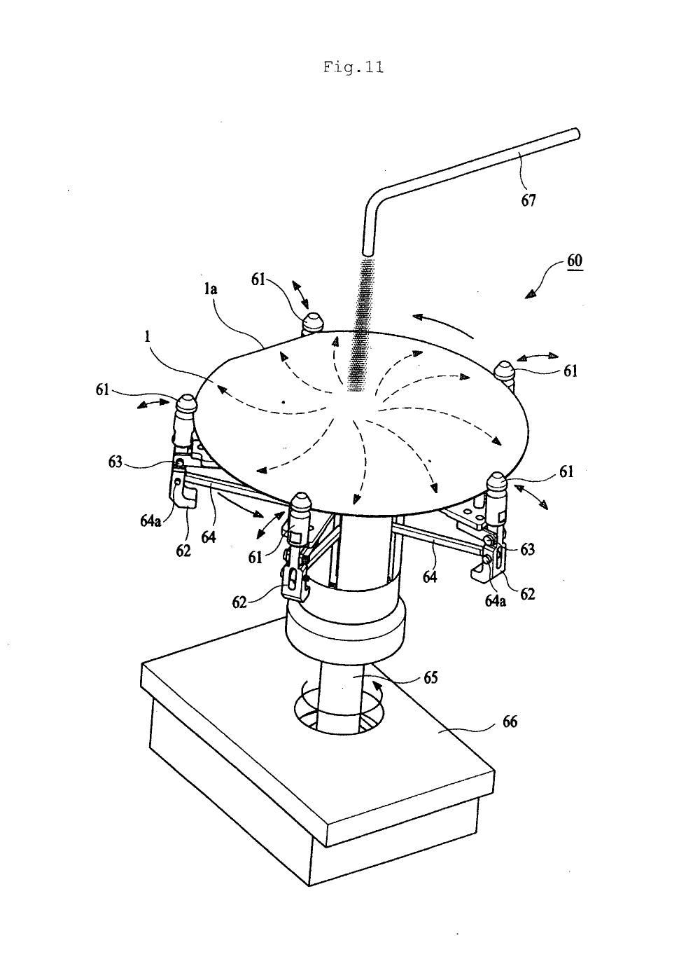

FIGS. 1 to 11 are drawings for explaining a semiconductor wafer cleaning system C according to the present invention. More specifically, FIG. 1 is a schematic view of a disposition structure regarding respective sections of a semiconductor wafer cleaning system C and a connectivity thereof with peripheral devices such as a polishing module P and a wafer receiving module F in a plane in accordance with the present invention. FIG. 2 is a perspective view of a main structure of a preliminary cleaning station 10 for removing large particles by a water screen type sprayer 18 of deionized water which is applied to a cleaning system C of the present invention. FIG. 3 is a cross-sectional view along the III-III line illustrated in FIG. 2. FIG. 4 is a perspective view of a main structure of a first cleaning station and a second cleaning station 20,40 by wetting brushes 21 which is applied to a cleaning system C of the present invention. FIG. 5 is a vertical cross-sectional view illustrating a flow structure of deionized water in a brush 21 which is applied to the first cleaning station and the second cleaning station 20,40. FIG. 6 is a perspective view of a main structure of a first rinsing station 30 arranged between the first cleaning station and the second cleaning station 20,40 for performing a rinsing process after a cleaning process by a first cleaning station 20 and for changing a transfer direction of a wafer 1. FIGS. 7 to 9 are a schematic top view and a schematic side view to explain a principle of a direction change and a transfer of a wafer 1 by a first rinsing station 30 in sequence. FIG. 10 is a perspective view of a main structure of a second rinsing station 50 which performs a rinsing process after cleaning process by the second cleaning station 40. FIG. 11 is a perspective view of a main structure of a dry station 60 utilizing centrifugal force applied to the present invention.

Typically, a cleaning system (Cleaner Module) C is arranged between a polishing module P where one or more CMP tools for finely polishing a wafer 1 are installed and a wafer receipt module (Equipment Front End Module) F for stacking multiple wafers 1 and receiving them as illustrated in FIG. 1.

One or more loading devices 3 for moving (loading) the wafers 1 to be polished onto a platen 2 of each CMP tool or moving (unloading) the polished wafers 1 from the platen 2 toward a subsequent cleaning system C are provided within the polishing module P. In connection with the loading devices 3, a robot arm 5 for transferring the wafers 1 into a preliminary cleaning station 10 of the cleaning system C after gripping them from the loading devices 3 or for transferring the transferred wafers 1 toward the loading devices 3 after gripping them from a cassette stage 4 of the wafer receipt module F by another robot arm (not shown) is provided.

The semiconductor cleaning system C according to the present invention comprises a preliminary cleaning station 10 for removing heavy particles on a wafer 1 in advance by spraying deionized water thereon; a first cleaning station 20 for cleaning remaining particles firstly by rotating frictionally a pair of brushes 21 disposed to be contacted with a front surface and a back surface of the wafer 1 and by spraying chemicals thereon; a first rinsing station 30 for rinsing by spraying a cleaning liquid onto the firstly cleaned wafer 1; a second cleaning station 40 for cleaning particles secondly remained on the front surface and the back surface of the wafer 1 by spraying the chemicals using the same structure and manner as those of the first cleaning station; a second rinsing station 50 for rinsing by spraying the cleaning liquid onto the secondly cleaned wafer 1; and a dry station 60 for drying the remained cleaning liquid using centrifugal force generated by rotating the rinsed wafer 1 at a high speed.

A wafer transfer between respective stations of the present invention is performed by respective transfer conveyers (refer to transfer conveyers 70 illustrated in FIGS. 6 and 10) which are installed through separation walls between the respective stations.

As illustrated in FIGS. 2 and 3, the preliminary cleaning station 10 is a device for gripping and rotating the wafer 1 by four guide rollers 16 and for removing particles by spraying highly pressured deionized water in a water screen shape from a deionized water sprayer (DIW Knife) 18 installed on top of the wafer 1, as a preliminary cleaning process for removing heavy particles on the wafer 1 by spraying deionized water.

The deionized water sprayer (DIW Knife) 18 is installed vertically downwardly on one side wall of the preliminary cleaning station 10. A deionized water supply hole 18a for being supplied from outside is formed on one side of the deionized water sprayer 18. When highly pressured deionized water is supplied through the deionized water supply hole 18a, deionized water is sprayed in a water screen shape through a spray hole formed to be a long hole and pushes particles toward an edge of the wafer 1. Thus, a maximum effect of removing particles can be available by a water screen type spray with a high pressure. In some other example, a rinsing process can be performed by the deionized water sprayer 18 after spraying chemicals and performing a chemical reaction before performing a preliminary cleaning process by deionized water.

Each of the guide rollers 16 is designed to rotate the wafer 1 by maintaining the edge around the wafer 1 in a closely adhered state within a groove thereof. The guide rollers 16 are able to move upward and downward with a small width in order for the wafer 1 not to be interfered by the respective guide rollers 16 when the wafer 1 is inputted into or outputted from the preliminary cleaning station 10. That is, a supporting plate 11 having through-holes at proper positions is fixedly installed vertically at one side of the preliminary cleaning station 10. An ascending and descending guide rail 11a is integrally formed along a vertical direction at an outer side of the supporting plate 11. An ascending and descending plate 13 is combined with the ascending and descending guide rail 11a along which the ascending and descending plate 13 ascends and descends. A cylinder 12 is fixed vertically on a bottom portion of the supporting plate 11 and a lower end of the at an end of the ascending and descending plate 13 is integrally connected to a cylinder rod 12a of the cylinder 12 thereby the ascending and descending plate 13 is to be ascended and descended by driving the cylinder 12. One end of a casing 17 for receiving roller axles 16a of the respective guide rollers 16 is integrally fixed to the ascending and descending plate 13 via a through-hole thereby is capable of ascending and descending along with the ascending and descending plate 13 Herein, a cover 17a capable of being opened for maintenance is combined with top of the casing 17. The roller axles 16a are received inside the casing 17 and rotatably supported by bearings 16d. Pulley followers 16c are fixed on the roller axles 16a, respectively, and are structured to be engaged by a belt 15b. A motor 14 is fixed at one side of the ascending and descending plate 13 and a driving pulley 14a formed at one end of an axle of the motor 14 and a pulley follower 16b formed on the roller axle 16 of either one of the guide rollers 16 are engaged by a belt 15a so that the respective guide rollers 16 rotate simultaneously as the driving pulley 14a rotates.

Accordingly, the present invention is structured that the ascending and descending plate 13, the casing 17, the respective guide rollers 16, and the motor 14 are ascended and descended all together as the cylinder 12 operates.

Meanwhile, the first cleaning station 20, as illustrated in FIG. 4, is a device comprising a pair of guide rollers 23 for supporting and rotating a side edge of the wafer 1, a pair of brushes 21, and a pair of chemical sprayers 26, as a main cleaning process for cleaning remaining particles firstly by frictionally rotating the brushes 21 disposed to be contacted with the front and back surfaces of the wafer 1 and by spraying chemicals through the chemical sprayers 26 separately provided.

As illustrated in FIGS. 4 and 5, the brush 21 is made of wetting sponge, i.e., porous PVA and formed with innumerable fine contact protrusions 21a on an outer surface thereof. The brush 21 performs a function of brushing up medium-sized particles and small-sized particles, etc. by physical force due to a rotating motion by a direct contact with both side surfaces of the wafer 1. Further, the brush 21 rotates in a constant direction to make the wafer have a property of moving toward the guide rollers 23 and is structured that the gap between the brushes 21 may be adjusted. In addition, the brush 21 has a hollow cylindrical shape and a brush axle 22 is to be inserted therein through a hollow portion. Both ends of the brush axle 22 are rotatably installed on both side walls of the preliminary cleaning station 10. A flow path 22a for supplying deionized water is formed inside the brush axle 22 and a plurality of holes 22b for ejecting deionized water is formed in a radial direction of the inner wall of the brush axle 22 so that deionized water may be supplied toward the brush 21 through the flow path 22a for supplying deionized water and the holes 22b for ejecting deionized water. Herein, the supply of deionized water through the brush 21 is used as a means for making the brush 21 in a proper wetting condition when the brush 21 idles.

As illustrated in a structure of the guide rollers 16 of the preliminary cleaning station 10 (see FIG. 3), the respective guide rollers 23 have a structure of connection where the roller axle 23a received inside the casing 25 is to be engaged with a pivot axle 24 for moving a roller by a belt (not shown). The respective guide rollers 23 also perform a function as a stopper which supports an edge of the wafer 1 in response to a forward movement of the wafer 1 caused by rotating the brush 21. Further, the pivot axle 24 for moving a roller has a mechanism that the respective guide rollers 23 swings left and right (or in both side directions) at a constant angle in order not to be interfered by the movement of the wafer 1.

In addition, the chemical sprayer 26 has a hollow cylindrical shape and a flow path 26a for supplying chemicals is formed inside the hollow portion. A plurality of spraying nozzles 26b is formed on an outer surface thereof. The chemical sprayers 26 are disposed symmetrically about both side surfaces of the wafer 1.

Meanwhile, the first rinsing station 30, as illustrated in FIG. 6, is to rinse the firstly cleaned wafer 1 by spraying cleaning liquids (for example, deionized water, etc.) thereon and is a device comprised of transfer conveyers 70 for transferring the wafer 1 forward in a moving direction thereof and a pair of cleaning liquid sprayers 37.

The transfer conveyers 70 comprise conveyer pulleys 71,71a disposed in parallel at both sides thereof with a predetermined gap, a conveyer belt 72 connected between the conveyer pulleys 71,71a, and conveyer brackets 73 for supporting the conveyer pulleys 71,71a. Herein, the conveyer pulley 71a has slightly different from the other conveyer pulley 71 in its structure. However, such a difference therebetween is a simple design change in that the conveyer pulley 71a has a structure of two-divided short sections in order to prevent interference with a direction change and transfer device which will be described in detail later.

The cleaning liquid sprayers 37 are not different from the structure of the chemical sprayer 26 of the first cleaning station 20 as described above. That is, the cleaning liquid sprayers 37 have a hollow cylindrical shape and a flow path 37a for supplying the cleaning liquids is formed inside the hollow portion, while a plurality of spraying nozzles 37b are formed on an outer surface.

Further, the present invention includes additionally a direction change and transfer roller device (RAT: Right Angle Transfer) which is structured to change the moving direction of the wafer 1 by 90 degrees when moving the wafer 12 into a subsequent cleaning process after an inputting process of the wafer into the first rinsing station 30 and a rinsing process thereof, in addition to the structure of the first rinsing station 30. With this, the respective stations are changed from a parallel arrangement in the prior art to an L-type arrangement and therefore are disposed in connection with peripheral devices such as a polishing module P and a wafer receiving module F, etc., which provides a structure for making a compact structure applicable to a whole unit including the cleaning system and maximizing the effectiveness of an occupied space of the whole unit.

That is, the direction change and transfer roller device (RAT) is structured that the ascending and descending plate 33 being ascended and descended by a certain linear motor (e.g., the ascending and descending device in the preliminary cleaning station 10, etc.) is disposed vertically; a plurality of roller brackets 32 is fixed to one side wall of the ascending and descending plate 33 vertically in parallel with a constant gap therealong and is arranged inside the respective roller brackets 32; and a plurality of direction change and transfer rollers 31 is supported in a manner that the direction change and transfer rollers 31 are arranged inside the roller brackets 32, respectively so that both ends of the direction change and transfer rollers 31 are rotatable between one side wall of the ascending and descending plate 33 and an end of the roller brackets 32. The respective direction change and transfer rollers 31 are arranged between the conveyer pulleys 71a of the transfer conveyers 70 without any interference therewith.

Accordingly, the direction change and transfer rollers 31 ascend and descend between the transfer conveyers 70 without any interference along with an ascending and descending movement of the ascending and descending plate 33. Hereinafter, a principle of direction change and transfer of the wafer 1 by a direction change and transfer device is described with reference to the accompanying drawings sequentially.

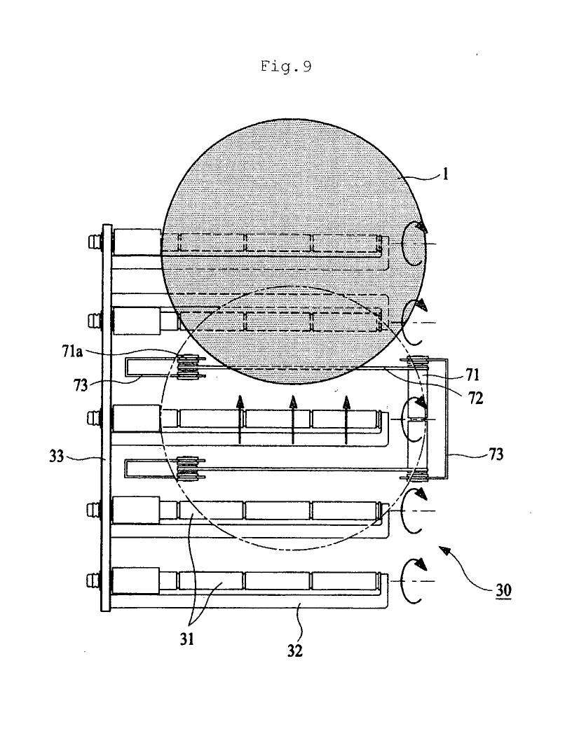

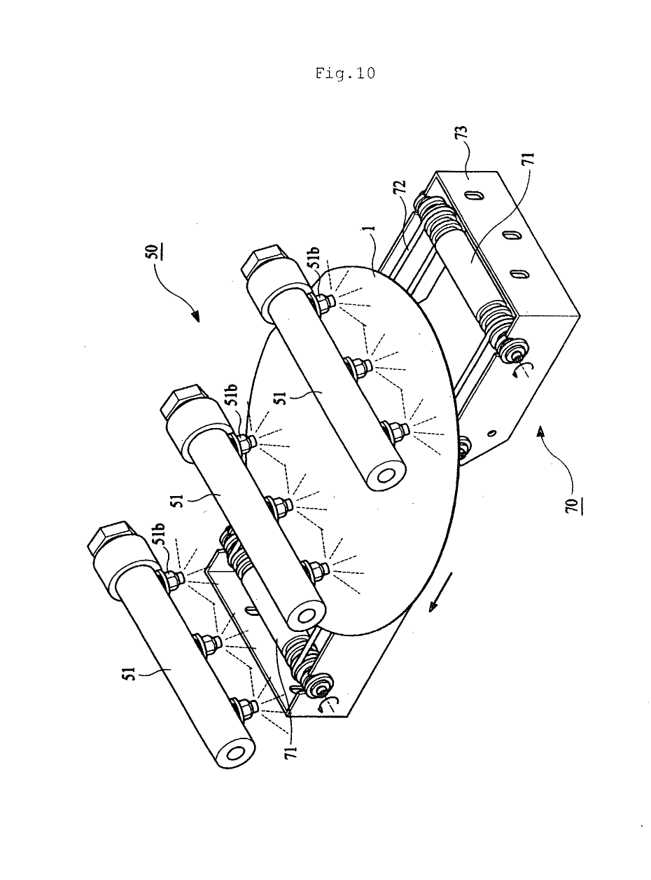

First, as illustrated in FIG. 7 which is a plan view, the wafer 1 which completes the process in the first cleaning station 20 enters into the first rinsing station 30 while riding on the conveyer belt 72 of the transfer conveyers 70, and then a rinsing process is performed through spraying deionized water by the cleaning liquid sprayer 37. Then, as illustrated in FIG. 8 which is a side view, the direction change and transfer rollers 31 which are placed below the conveyer belt 72 of the transfer conveyers 70 ascend between the transfer conveyers 70 up to a position which is slightly higher than the position of the conveyer belt 72 as the ascending and descending plate 33 ascends, and therefore lift the wafer 1 sit on the conveyer belt 72. With this condition, as illustrated in FIG. 9 which is a plan view, as the direction change and transfer rollers 31 turn to a forward transfer direction, the moving direction of the wafer sit hereon is changed into 90 degrees and the wafer 1 enters into the second cleaning station 40.

Meanwhile, the second cleaning station 40 is a device for cleaning particles remained on the front surface and the back surface of the wafer 1 secondly by spraying chemicals which may be the same as or different from the chemicals used in the first cleaning station 20. The second cleaning station 40 has the same structure and method as those of the first cleaning station 20 (see FIGS. 4 and 5) and thus, the specific explanation thereof is omitted herein and the same reference numerals are assigned for the same components in both the first cleaning station and the second cleaning station 20,40.

Further, the second rinsing station 50, as illustrated in FIG. 10, is to rinse finally by spraying cleaning liquids (e.g., deionized water, etc.) on the secondly cleaned wafer 1. The second rinsing station 50 is a device comprised of transfer conveyers 70 for transferring a wafer 1 and cleaning liquid sprayer 51 being installed above the wafer 1 for spraying deionized water toward a surface of the wafer 1. Reference numeral 51b indicates a spraying nozzle, and an ultrasonic device (Mega-sonic) may be additionally installed to the second rinsing station 50 as an option so that a cleaning process may be simultaneously performed by the ultrasonic operation thereby activate the final cleaning effect more significantly.

With the rinsing of the wafer 1 independently and sufficiently by the second rinsing station 50, the rinsing process of the present invention is more effectively performed than the prior art rinsing process in which the rinsing process is performed simultaneously in a subsequent dry station 60 and therefore more significant effect may be expected to shorten the process time of the dry station which is a main factor for a delayed phenomenon in a whole cleaning process currently.

In the meanwhile, the dry station (SRD: Spin Rinse Dry) 60, as illustrated in FIG. 11, is to rotate the finally rinsed wafer 1 at a high speed and dry remained cleaning liquids such as deionized water by its centrifugal force. The dry station 60 is a device comprising a finger grip device for gripping a wafer 1 and rotating it at a high speed.

The finger grip device is a device for gripping an edge of the wafer 1 with equidistance and rotating it at a high speed. In the finger grip device, a central rotation axle 65 is extended upward which is rotated by a power transferred from a driving device 66 provided at a bottom. At the top of the central rotation axle 65, five cut-outs are formed along an outer circumference thereof with equidistance in a longitudinal direction thereof. Operational levers 64 are protruded through the five cut-outs, respectively, in a radial direction, which have a same distance and are capable of moving upward and downward along the five cut-outs. Finger arms 62 are provided vertically in a manner that each finger arm 62 is combined with one end of each operational lever 64 in a rotatable condition by way of a hinge pin 64a so that each finger arm 62 is engaged with each operational lever 64 as each operational lever 64 moves. On top of the finger arms 62, grip fingers 61 are formed integrally with the finger arms 62, respectively, each grip finger 61 having a groove capable of receiving an edge of the wafer 1. A connection member is provided between the hinge pin 64a of the finger arm 62 and the grip finger 61. In the connection member, a central axis pin 63 is connected to a sitting plate for supporting the wafer 1 when being loaded and functions a pivot axis to perform a relative swing motion between the finger arms 62 and the grip fingers 61.

The grip finger 61 has similar operation structure to one of human fingers as if human finger ends grip the edge of a circular plate, etc. after the fingers spread widely with a constant gap therebetween.

With the structure of the finger grip device described above, the wafer 1 loaded on the sitting plate is gripped firmly by the five grip fingers 61 and thus is rotatable simultaneously when the central rotation axle 65 rotates. When unloading the wafer 1, the operational lever 64 is contracted toward a central direction of the central rotation axle 65 by a mechanical manipulation and thus draws the bottom portion of the finger arm 62 so that the top portion of the grip finger 61 spreads in a radial direction about the central axis pin 63 as a pivot point and releases the wafer 1. When gripping the wafer 1, operations reverse to the operations described above are performed and thus a detailed description thereof is omitted herein.

Further, the five grip fingers 61 are disposed along an outer circumference with equidistance and thus the distance between the grip fingers 61 maintains 72 degrees. Especially, although a flat zone type wafer 1 is inputted without any alignment operation, at least four effective grip fingers 61 grips the circumference of the wafer 1 covering 216 degrees much more exceeding 180 degrees, thereby maintains a firm grip condition. This embodies stableness of a device significantly superior to an unstable condition in a prior art structure having four grip fingers wherein only 180 degrees is gripped along the circumference of a wafer by at least three effective grip fingers when a flat zone type wafer 1 is inputted without any alignment operation.

Accordingly, the present invention embodies a stable structure maintaining a constant grip condition regardless of an input direction of the wafer 1 and without any breakage of the wafer when rotating it at a high speed by improving a wafer grip structure into a five grip finger type 61.

It is easily understood by a skilled person in the art that the number of the grip finger 61 may be designed differently depending on a flat zone type wafer or a notch type wafer. That is, the grip finger type may be structured by applying five grip fingers 61 for a flat zone type wafer and three or four grip fingers 61 for a notch type wafer, respectively. However, either grip ginger structure described above may be applied to the dry station 60 in accordance with the present invention, regardless of the types of the wafer 1. A five grip finger structure is more preferable in order to input and operate the wafer 1 directly without any additional alignment operation of wafer such as a wafer center alignment, etc.

In addition, on top of the dry station 60, a sprayer of deionized water and nitrogen gas for spraying deionized water (or nitrogen gas) and performing a final rinsing process before performing a dry process is additionally included, if necessary. In such a case, after spraying deionized water and performing a rinsing process while rotating the finger grip device at a low speed, nitrogen gas is sprayed while rotating the finger grip device at a high speed thereby accomplishes an improved dry performance as well as an anti-oxidation treatment of the surface of the wafer 1 by an reaction of nitrogen gas with oxygen existing in air.

Although the present invention is described with reference to the embodiments illustrated in the drawings, it shall be interpreted as illustrative rather than limiting. Therefore, it is obvious by a skilled person in the art that various modifications and equivalent embodiments may be conceivable and should fall upon the scope of the present invention. Thus, the breadth and scope of the present invention should be defined by the following claims appended hereto.

### INDUSTRIAL APPLICABILITY

The wafer cleaning system of the present invention minimizes a waiting time of entry into each cleaning station by processing a cleaning operation and a rinsing operation of a surface-polished wafer in a cleaning station and a rinsing station which are provided separately and independently thereby improves wafer productivity significantly by solving a delayed phenomenon in a whole process of wafer manufacturing.

What is claimed is:

1. A semiconductor wafer cleaning system comprising:
a preliminary cleaning station for removing particles on a wafer in advance by spraying deionized water thereon;
a first cleaning station for cleaning remaining particles firstly by rotating frictionally a pair of brushes disposed to be contacted with a front surface and a back surface of the wafer and by spraying chemicals thereon through a chemical sprayer being provided independently;
a first rinsing station for rinsing by spraying a cleaning liquid onto the firstly cleaned wafer at the first cleaning station;
a second cleaning station for cleaning particles secondly remained on the front surface and the back surface of the wafer by spraying the chemicals onto the firstly rinsed cleaned wafer at the first rinsing station through a chemical sprayer being provided independently using the same structure and manner as those of the first cleaning station;
a second rinsing station for rinsing by spraying the cleaning liquid onto the secondly cleaned wafer at the second cleaning station; and
a dry station for drying the remained cleaning liquid using centrifugal force generated by rotating the rinsed wafer at the second rinsing station at a high speed.

2. The semiconductor wafer cleaning system according to claim 1,
wherein the first rinsing station further comprises a direction change and transfer device for changing the moving direction of the firstly cleaned wafer into a subsequent process by 90 degrees against the entry direction of the firstly cleaned wafer into the first rinsing station and transferring the firstly cleaned wafer thereinto.

3. The semiconductor wafer cleaning system according to claim 2,
wherein the direction change and transfer device comprises a ascending and descending plate being disposed vertically and ascended and descended by a certain linear motion device; a plurality of roller brackets being fixed to one side wall of the ascending and descending plate vertically in parallel with a constant gap therealong and being arranged between transfer conveyers for transferring the wafer from a previous process without interference between the roller brackets and the transfer conveyers; and a plurality of direction change and transfer rollers being supported in a manner that the direction change and transfer rollers are arranged inside the roller brackets, respectively so that both ends of the direction change and transfer rollers are rotatable between one side wall of the ascending and descending plate and an end of the roller brackets.

4. The semiconductor wafer cleaning system according to claim 1,
wherein the preliminary cleaning station comprises a wafer grip and rotation device; and a deionized water sprayer being installed on top of the wafer for mainly removing heavy particles by spraying deionized water in a water screen shape when feeding highly pressured deionized water;
wherein the wafer grip and rotation device comprises a supporting plate in which an ascending and descending guide rail is formed along a vertical direction; an ascending and descending plate being combined with the ascending and descending guide rail in order to be guided by the ascending and descending guide rail; a cylinder being extended and contracted vertically to ascend and descend the ascending and descending plate; and a plurality of guide rollers being to be rotated simultaneously by one or more driving sources to rotate the wafer after gripping it and being ascended and descended together with the ascending and descending plate in order not to interfere with the wafer when loading and unloading the wafer.

5. The semiconductor wafer cleaning system according to claim 1,
wherein the first cleaning station and the second cleaning station respectively comprise a pair of brushes for cleaning the wafer by contacting with both surfaces thereof and being made of wetting sponge capable of wetting treatment upon being supplied deionized water only through a flow path for supplying deionized water when the brushes idle; and a chemical sprayer being disposed symmetrically toward both side surfaces of the wafer and being capable of passing chemicals only and spraying them.

6. The semiconductor wafer cleaning system according to claim 1,
wherein the dry station comprises a central rotation axle being extended upward which is rotated by a power transferred from a driving device provided at a bottom thereof; five cut-outs being formed at the top of the central rotation axle along an outer circumference thereof with equidistance in a longitudinal direction thereof; operational levers being protruded through the five cut-outs, respectively, in a radial direction, and having a same distance and being capable of moving upward and downward therealong, respectively; finger arms being provided vertically in a manner that each finger arm is combined with one end of each operational lever in a rotatable condition by way of a hinge pin so that each finger arm is engaged with each operational lever as each operational lever moves; grip fingers being formed integrally with the finger arms, respectively, on top of the finger arms, each grip finger having a groove capable of receiving an edge of the wafer; a connection member being provided between a top portion of the hinge pin of the finger arm and the grip finger; and, in the connection member, a central axis pin being connected to a sitting plate for supporting the wafer when being loaded and functions a pivot axis to perform a relative swing motion between the finger arms and the grip fingers.
